(19) United States
(12) Patent Application Publication
(10) Pub. No.: US 2026/0163768 A1
(43) Pub. Date: Jun. 11, 2026

(54) Methods for Implementing Variable Interval Usage Codes In Communication Networks

(71) Applicant: Charter Communications Operating, LLC, St. Louis, MO (US)

(72) Inventors: Roger G. STAFFORD, Thornton, CO (US); Jay T. LIEW, Parker, CO (US)

(21) Appl. No.: 18/973,423

(22) Filed: Dec. 9, 2024

(51) Int. Cl. H04L 25/40

(52) U.S. Cl. CPC H04L 25/40

(57) ABSTRACT

A method performed by a computing device formats Interval Usage Codes (IUCs) for enhancing cable service network communications between cable modems and a Cable Modem Termination System (CMTS). The method includes constructing an IUC 13 by implementing a default modulation usable by all cable modems within a communication channel, applying pre-filter to Received Modulation Error Ratio (RxMER) files to exclude files with a threshold number of sub-channels below a defined quality level, excluding FM radio frequencies from this filtering. The method identifies exception frequency zones with impaired conditions based on filtered RxMER data, assigns reduced modulation settings for these zones to ensure reliable communications, and applies a post-filter to verify an average channel bit density of at least 5 bits per Hz per symbol, excluding FM radio frequencies. The IUC 13 is then provided to the CMTS for transmission to cable modems to optimize upstream communication.

### BACKGROUND

Modern telecommunications standards enable high-bandwidth data transfer over Cable Television (CATV) and Hybrid Fiberoptic/Cable (HFC) networks. For example, telecommunications standards, such as Data Over Cable Service Interface Specification (DOCSIS) 3.1, enable the use of multiple Orthogonal Frequency Division Multiplexing (OFDM) channels to carry data in established regions of 10 frequency spectrum. Some regions of frequency spectrum are known to support a required level of modulation, such as Orthogonal Frequency-Division Multiple Access (OFDMA), 2K-Quadrature Amplitude Modulation (16K-QAM), 1K-QAM, or lower. Generally, data transfer is carried out over channels defined in terms of frequencies, modulation settings, and other parameters that are provided to cable modems by the network.

### SUMMARY

Various aspects include methods and computing systems implementing the for formatting Interval Usage Codes (IUCs) for supporting cable service network communications between modems (e.g., cable modems) and a network controller. For example, a network controller may include a terminal device or terminal system such as a Cable Modem Termination System (CMTS), fiber optical line terminal (fiber OLT), fiber optical network terminal (fiber ONT). Various aspects may include constructing an IUC 13 code by: implementing a default modulation for a communication channel using IUC 13 that can be used by all modems communicating with the network controller, applying a pre-filter to RxMER files generated by the modems over a preceding time period to ignore an RxMER file that has a first threshold number of sub-channels below a second threshold value of channel quality, this pre-filter not applying to sub-channels within the FM radio frequency region of 88-108 MHz, identifying up to 16 exception frequency zones with impaired channel conditions within a frequency range of the communication channel based on the filtered RxMER files, identifying reduced modulation settings for each of the identified exception frequency zones in the communication channel to support reliable communications, and applying a post-filter to the overall channel to ensure that an average bit density in the overall channel is greater than or equal to 5 bits per Hz per symbol excluding the FM radio frequency region of 88-108 MHz, and providing the generated IUC 13 to the network controller for communication to the modems.

In some aspects, the first threshold value and the second threshold value may be definable in software. In some aspects, the first threshold value may be between 10 percent and 20 percent of sub-carriers in the channel, and the second threshold value may be 26 dB. In some aspects, the default modulation for IUC 13 may be QAM-64. In some aspects, the preceding time period of RxMER files used for constructing the IUC 13 code may be 48 hours or longer. In some aspects, IUC 13 includes up to 16 exception frequency zones.

Some aspects may further include generating an error event in response to either of the pre-filter or post-filter being triggered, and transmitting the generated error event to a network computing device to inform an operator.

Some aspects may further include configuring one or more of IUC 9 through IUC 12 based on RxMER files generated by modems using a respective IUC over a preceding period that is less than or equal to the preceding period of RxMER data used in constructing the IUC 13 code, in which IUC 9 through IUC 12 can have up to 16 exception frequency zones, and in which the exception frequency zones identified for IUC 13 match a combination of the exception frequency zones in IUC 9 through IUC 12. In some aspects, each of IUC 9 through IUC 12 may be configured with the same default modulation.

In some aspects, when an OUDP for monitoring leakage of signal in the aeronautical band is transmitted in the communication channel, one of the 16 exception frequency zones is reserved for the OUDP pattern, and the modulation identified for use in the exception frequency zone reserved for the OUDP pattern is selected to be less than any modulation setting identified for any overlapping exception frequency zone based on RxMER data.

Some aspects may include a computing device, such as a CMTS or a server coupled to the CMTS, that includes a memory and a processing system configured to perform operations of any of the aspect methods summarized above. Some aspects may include a non-transitory processor-readable medium having stored thereon processor-executable instructions configured to cause a processing system of a computing device, such as a CMTS or a server coupled to the CMTS, to perform operations of any of the aspect methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of various embodiments.

FIG. 1 is a block diagram illustrating a network suitable for implementing some embodiments.

FIG. 2 is a message flow diagram showing sequences of messages involved in implementing some embodiments.

FIG. 3A illustrates four cases of interactions between a PMA defined frequency exception and the OUDP frequency exception.

FIGS. 3B-3D are code listings corresponding to three cases of interactions between a PMA defined frequency exception and the OUDP frequency exception.

FIG. 4 is a block diagram of an example PMA module computing device illustrating hardware and functional modules suitable for implementing various embodiments.

FIG. 5 is a process flow diagram illustrating a method for defining an IUC 13 according to some embodiments.

FIGS. 6A-6B are process flow diagram illustrating further operations for defining IUCs and managing communications between modems and the network interface according to some embodiments.

FIG. 7 is a component diagram of an example server suitable for implementing various embodiments.

### DETAILED DESCRIPTION

The various embodiments will be described in detail with reference to the accompanying drawings. The same reference numbers will be used throughout the drawings to refer to the same or like parts wherever possible. References to particular examples and implementations are for illustrative purposes and are not intended to limit the scope of the invention or the claims.

In overview, various embodiments include methods and systems for formatting Interval Usage Codes (IUCs), particularly IUC 13, to enhance upstream communications from modems (e.g., cable modems) to the network controller (e.g., a terminal device or terminal system such as a Cable Modem Termination System (CMTS), fiber optical line terminal (fiber OLT), fiber optical network terminal (fiber ONT)) under diverse operating conditions. The methods may be implemented within a processing system of a network computing device, such as a server coupled to the network controller, or directly within the processor of the network controller. Embodiment methods leverage measured error rate data received from cable modems to dynamically identify exception frequency zones within communication channels and define appropriate modulation levels for such zones to optimize upstream performance.

In some embodiments, the system generates IUC 13 with a channel default modulation of 64-QAM (equivalent to 6 bits/Hz per symbol), which serves as the highest modulation level used in the channel. To address radio frequency (RF) ingress into the network, IUC 13 may define up to 16 exception frequency zones, with the actual number of zones varying from 0 to 16 based on channel conditions. These exception zones allow for modulation adjustments, such as reducing the modulation scheme (e.g., to 32-QAM or 16-QAM), within exception frequency zones experiencing impairments. Additionally, IUCs 9 through 12 are configured to match this capability, also supporting up to 16 exception frequency zones each.

When an Orthogonal Frequency Division Multiplexing Universal Data Packet (OUDP) is present in a channel, one of the exception frequency zones is reserved for the OUDP pattern. The system uses profile management techniques to overlay reduced modulation settings for the OUDP exception zone on existing modulations of exception zones based on Received Modulation Error Ratio (RxMER) data, ensuring OUDP modulation settings takes precedence in cases of overlap.

To prevent the IUC 13 average bit density from falling below a functional threshold, the processing system may use pre-filters during processing. A first pre-filter excludes subcarriers with RxMER values of unacceptable quality, such as 26 dB or less, based on RxMER files collected over a specified interval, such as 48 hours. This exclusion applies across the channel except within the FM radio frequency region of 88-108 MHz, which is excluded from calculations due to the fact that ingress of radio frequency (RF) energy reduces the bit rates achievable in the FM frequency region. This ensures that sub-channels (i.e., subcarriers or mini-slots) in the FM ingress region are not factored into modulation-level calculations.

Before generated IUCs are used by the CMTS, the processing system may apply a post-filter to ensure that the resulting IUCs, including IUC 13, have average bit densities that meet or exceed a minimum threshold, such as 5 bits/Hz per symbol, excluding the FM ingress region. This additional filter ensures that the generated IUCs supports robust and efficient upstream communication while accommodating the effects of RF ingress and other interference.

In some embodiments, if any of the pre-filter or post-filter is triggered, an error event report is generated identifying the triggering filter and the MAC addresses of each service group that causes the error detection trigger, with the error event report transmitted to a computer technical group that can investigate the cause and perhaps take action to reduce recurrence.

The terms “component,” “module,” “operation,” and the like are used in this application to refer to various computer-related entities tasked with specific operational functions. These may include hardware components, software programs, combinations thereof, or processes in execution. For example, a component or a module may be a software application made of multiple operations that execute on a computing device, a processor executing instructions, a thread of a program, or the device itself. Components and modules may operate individually within a single processing environment or may be distributed across multiple processing units to utilize the capabilities of multicore or parallel computing architectures. Components may execute instructions (which may be referred to as modules) stored on different types of non-transitory computer-readable media and communicate via local or remote process interactions, inter-process communications, electronic signaling, data packet transfers, and other established protocols for data exchange and function coordination.

The term “processing system” is used herein to refer to one or more processors, including multi-core processors, that are organized and configured to perform various computing functions, such as performing functions of a server. Various embodiment methods may be implemented in one or more of multiple processors within a processing system as described herein.

DOCSIS, or the Data Over Cable Service Interface Specifications, is a set of telecommunications standards for defining requirements for networks used primarily for delivering high-speed data services, such as internet and file delivery, over cable television systems. DOCSIS enables the addition of high-bandwidth data transfer to an existing cable TV (CATV) system, for example, which is particularly useful for broadband internet and file sharing applications. The DOCSIS standard defines modulation, channel access methods, and security protocols to facilitate fast and secure data delivery through cable services networks. DOCSIS supports multiple versions, each offering improvements in speed, efficiency, and capabilities, thereby ensuring the standard can meet evolving technological demands and enhance user experiences in data-intensive applications. While DOCSIS refers to “Data over Cable” and references are made herein to “cable modems” and “cable services networks,” various embodiments may be equally applicable to networks that are not limited to cables (e.g., coaxial cables) for transmitting data, such as hybrid fiberoptic/cable (HFC) networks, and other networks.

As used herein, the term “channel” refers to a defined frequency range allocated for communication in accordance with DOCSIS standards. A channel encompasses an overall frequency range, within which data is transmitted using a default modulation scheme specified in an Interval Usage Code (IUC), such as 1K-QAM in IUCs 9-12 and 64-QAM in IUC 13 in some embodiments. The channel is further characterized by signaling parameters that include, but are not limited to, modulation order, Forward Error Correction (FEC) settings, pilot patterns for synchronization, and symbol timing structures. These parameters are collectively configured to enable efficient and reliable data communication, ensuring compatibility with all modems operating within the network. The channel serves as the fundamental unit of frequency allocation and resource management in DOCSIS-based communication systems.

As used herein, the term “sub-channel” refers to specific frequency ranges within the broader frequency range of a channel defined in an Interval Usage Code (IUC). In the context of DOCSIS standards and related technologies, these frequency ranges may also be referred to as “sub-carriers” or “mini-slots,” depending on the modulation and allocation mechanisms employed. The use of the term “sub-channel” in this disclosure is intended to encompass these equivalent terms, reflecting the granularity of frequency-based resource allocations within a channel.

Networks implementing DOCSIS standards may use Orthogonal Frequency-Division Multiple Access (OFDMA) modulation to provide communication channels. Such channels are a defined frequency range within the spectrum allocated for upstream or downstream communications. Within this frequency range, the channel is further divided into sub-channels, which are subsets of frequencies corresponding to individual subcarriers or groups of subcarriers. The sub-channels are defined by orthogonal frequency-division modulation, ensuring that each subcarrier is orthogonal to others and does not interfere with adjacent subcarriers. Each sub-channel can be assigned and use a different modulation scheme, such as 4K-QAM, 2K-QAM, 1K-QAM, etc., depending on the signal quality and network conditions. Sub-channels can be flexibly allocated for data transmission based on network requirements, enabling multiple modems to transmit simultaneously on different subcarriers. While channels and sub-channels are primarily defined by their frequency domains, their usage may also be defined by time-based allocation mechanisms (such as mini-slots) that determine when specific sub-channels are active, allowing a combination of frequency and time domain techniques to maximize efficiency and adaptability.

Interval Usage Codes (IUCs) are codes or identifiers used to define the characteristics of upstream transmission bursts between cable modems and the CMTS. Each IUC specifies parameters such as modulation type, FEC, preamble length, and burst timing, enabling efficient bandwidth management and robust data transmission. The CMTS communicates the available IUCs and their associated burst parameters to cable modems within service groups through the Upstream Channel Descriptor (UCD) messages. This framework ensures that the cable modems may transmit data to the CMTS in accordance with the operational and environmental conditions of the upstream channel.

The DOCSIS 3.1 standard assigns specific purposes to individual IUCs. For example, IUC 1 is used when a cable modem has Internet Protocol (IP) data to transmit, while IUC 3 is utilized during the initial registration of the cable modem with the CMTS. For ongoing network maintenance, IUC 4 is sent by the cable modem at regular intervals, typically every 30 seconds. IUC 5 and IUC 6 designate short and long data grants, respectively, allowing the CMTS to manage upstream user data packets of varying sizes. IUCs 9 through 12 are Advanced TDMA (A-TDMA) burst profiles with specialized information elements to optimize upstream transmissions for specific applications. IUC 13 is referred to as the Default Data IUC as this message communicates the most robust and universally compatible burst profile. This IUC ensures reliable communication across all cable modems, even under suboptimal channel conditions.

The CMTS may define multiple OFDMA profiles for use by cable modems in the upstream channel. Each profile may assign different modulation orders to sub-channels within the channel, allowing the system to adapt to varying conditions and optimize throughput. However, in embodiments in which a profile management application is not implemented, each profile (and its associated IUC) applies a single modulation order across all sub-channels.

A DOCSIS 3.1 CMTS supports the creation of multiple OFDMA Upstream Data Profile IUCs for modems within a service group channel, providing flexibility in handling diverse communication needs. Individual cable modems are limited to maintaining only two active OFDMA Upstream Data Profile IUCs on a given channel at any time. This restriction simplifies the modem's internal operations and ensures efficient utilization of processing resources, while still offering the benefits of configurable burst profiles tailored to the characteristics of the OFDMA channel. This arrangement balances flexibility and efficiency, enabling the DOCSIS 3.1 standard to support advanced upstream communication features.

In the context of OFDMA communication channels, the term “exception frequency zones” refers to specific frequency bands within a channel that are designated for modified transmission parameters to address ingress noise or interference impairments or ensure detectability of special signals such as signals used to detect leakage of RF energy in the 108-137 MHz aeronautical band. The CMTS may implement exception frequency zones by dynamically adjusting the modulation scheme of subcarriers or sub-channels within the designated frequency range to a lower-order modulation scheme, which provides increased error resilience. Quadrature Amplitude Modulation (QAM) is a modulation technique used in digital communications, including in OFDMA systems, to encode data by varying both the amplitude and phase of a carrier signal, enabling efficient use of bandwidth by transmitting multiple bits per symbol on each subcarrier. For example, the CMTS may implement exception frequency zones by dynamically adjusting the QAM scheme of sub-channels, such as shifting the modulation of a sub-channel frequency band from 1K-QAM used in the rest of the channel to 512-QAM or 256-QAM.

Exception frequency zones are particularly useful for mitigating the effects of localized interference, such as ingress from FM radio signals or localized RF energy sources, by ensuring robust data transmission in the affected frequencies despite the adverse signal conditions. Adjusting the modulation scheme in affected sub-channels enables adaptive and efficient use of the full spectrum of a channel because subcarriers outside the exception frequency zones may continue to operate at higher-order modulation schemes, optimizing overall channel performance. As described herein, the configuration of exception frequency zones may be based on recorded error rates (RxMER data) in communications over a period of time (e.g., preceding 48 hours for IUC 13), with adjustments to modulation schemes in sub-channels communicated to the cable modems in IUC signals (e.g., IUCs 9-13) to ensure reliable operation of the OFDMA channel.

Received Modulation Error Ratio (RxMER) files refer to diagnostic data reports generated by cable modems that provide detailed measurements of demodulation errors, a critical metric for assessing signal quality. RxMER represents the ratio of the average power of the modulated signal to the average error power caused by noise, distortion, or other impairments, accounting for factors such as ingress, phase noise, and intermodulation distortion. RxMER files typically include subcarrier-level or channel-level data, detailing RxMER values for individual subcarriers (in OFDMA channels) or for entire channels in traditional QAM-based systems. These files may also contain information such as the frequency range and bandwidth of the measurements, timestamps, and flags identifying specific impairments. The data in RxMER files are gathered by the cable modems through continuous monitoring of received signals and communicated to the CMTS or network management systems for analysis and troubleshooting. The files are stored in network diagnostic systems or management platforms for use in identifying impairments, such as ingress or interference, and for optimizing channel performance by dynamically adjusting transmission parameters, including modulation schemes and exclusion of impaired sub-channels. RxMER files enable network operators to maintain high-quality communication by providing real-time insights into network health and signal conditions.

The DOCSIS 3.1 standard introduces the Profile Management Application (PMA), which is a software module that executes within a computing device of a cable services network to manage network performance by dynamically managing modulation profiles for both downstream and upstream channels. These profiles determine the modulation order assigned to each sub-channel (i.e., subcarrier or mini-slot) within OFDM channels, directly impacting data throughput and robustness against impairments. The PMA module analyzes network conditions and signal quality metrics, such as the RxMER, to create and assign appropriate profiles to groups of cable modems. This dynamic assignment allows the CMTS to adapt to varying channel conditions, ensuring efficient and reliable data transmission. This may be accomplished for upstream (i.e., cable modem to CMTS) communications by the CMTS sending different data IUCs to different service groups of cable modems. As noted above, a DOCSIS 3.1 cable modem may have up to two active OFDMA Upstream Data Profile IUCs on a given channel.

In various embodiments, the PMA module uses the same default modulation for each of IUCs 9-12, which is set based on the highest modulation error ratio in RxMER files provided by the cable modems to the CMTS within a preceding period (e.g., 8, 12, 24 or 48 hours), and then modified with reduced modulation schemes within sub-channels (i.e., mini-slots or sub-carriers) in which RxMER files indicate interference or noise to construct an IUC that is most suitable for a service group of cable modems based on network performance data. This enables the CMTS to optimize upstream transmissions by constructing IUCs that provide the highest data rates while maintaining acceptable error rates, thereby enhancing overall network efficiency for different service groups of connected cable modems.

In DOCSIS 3.1 networks, Interval Usage Code (IUC) 13 is a robust upstream data profile that enables reliable communication between cable modems and the CMTS under diverse operating conditions. IUC 13 is universally applicable and designed to ensure compatibility across all cable modems within the network. The configuration of IUC 13 includes several critical parameters, such as the modulation order, which defines the default modulation scheme (e.g., 64-QAM) used to determine the number of bits transmitted per symbol, and the pilot pattern, which specifies the arrangement of pilot subcarriers within the OFDMA channel. These pilot subcarriers facilitate accurate channel estimation and synchronization, essential for maintaining communication integrity. Additionally, IUC 13 includes error correction protocols that define the Forward Error Correction (FEC) mechanisms used to detect and correct errors during data transmission, as well as symbol timing parameters that ensure precise coordination between transmitting and receiving devices. To improve reliability, the preceding period used for assessing RxMER files for identifying the highest modulation and the exception frequency zones for IUC 13 may multiple days, such as 48 hours in some embodiments. This may be a longer duration than the preceding period of RxMER data that may be used by the processing system for selecting the highest modulation and identifying exception frequency zones in IUCs 9-12.

Since cable modems may only have two active OFDMA upstream data provide IUCs on a given channel and IUC 13 is configured to be a default IUC that every cable modem may use, the CMTS may assign one of IUCs 9 through 12 plus IUC 13 (i.e., IUCs 9 and 13, IUCs 10 and 13, IUCs 11 and 13, or IUCs 12 and 13), thereby enabling the cable modems to use the channel profile defined in IUC 13 if necessary.

As noted above, the PMA module executing in a processing system within or connected to the CMTS constructs IUC 13 based on performance metrics, such as stored in data files of RxMER data, which measures the signal quality of the upstream channel. By analyzing these metrics, the CMTS determines the most appropriate configuration for IUC 13, balancing high data rates with reliable communication. The parameters of IUC 13 are tailored to optimize data throughput while providing resilience against noise and interference, allowing the system to dynamically adapt to varying channel conditions and ensure efficient upstream communication.

In contrast to IUC 13, which is designed as a universally applicable and robust upstream data profile, IUCs 9 through 12 are Advanced TDMA (A-TDMA) burst profiles tailored for specific upstream communication scenarios and applications. While IUC 13 includes default modulation settings, such as 64-QAM, and can incorporate exception frequency zones to address ingress and interference, IUCs 9 through 12 offer enhanced flexibility and specialized features optimized for higher efficiency and lower latency in certain network conditions. For example, IUCs 9 through 12 are typically configured with higher modulation schemes, advanced error correction protocols, and more precise timing parameters to maximize data throughput in favorable channel conditions. Unlike IUC 13, which serves as the fallback profile under adverse conditions, IUCs 9 through 12 are dynamically assigned to modems based on specific service requirements and channel quality metrics, allowing for the implementation of specialized burst formats to achieve network optimization goals. Additionally, like IUC 13, IUCs 9 through 12 may also include up to 16 exception frequency zones to manage localized impairments, ensuring consistent performance across all upstream burst profiles.

In DOCSIS 3.1 networks, the construction of Interval Usage Codes (IUCs) 9 through 12 is managed by a PMA module, which executes within a processing system that is either integrated into or coupled to the CMTS. The PMA module receives RxMER data reported by cable modems to the CMTS, spanning a defined time window, such as the preceding 8, 12, 24 or 48 hours in some embodiments. Using this data, the PMA identifies specific sub-channels within the OFDMA channel where signal disruptions, such as noise or interference, degrade channel quality. These sub-channel regions are referred to as “exception frequency zones” or “exception zones.” As noted above, while modulation and exception frequency zones for IUCs 9-12 may be based on RxMER data over the preceding 8, 12, 24 or 48 hours, the preceding period used for assessing RxMER files for identifying the highest modulation and the exception frequency zones for IUC 13 may be longer, such as 48 hours in some embodiments.

In various embodiments, each of IUCs 9-12 may have the same default modulation scheme, such as 1K-QAM. Then for each identified exception frequency zone, the PMA module determines the necessary reduction in the modulation scheme to ensure reliable data communications. For example, in an OFDMA channel defined by one of IUCs 9-12 with a default modulation of 1K-QAM, the PMA may assign a reduced modulation of 512-QAM to a sub-channel within an exception zone to accommodate degraded signal conditions observed in RxMER files within the exception frequency range. Once these modulation setting adjustments are identified, the PMA constructs the IUC (e.g., one of IUCs 9 through 12) for the channel, specifying the default modulation scheme for the channel and the reduced modulation schemes for each exception frequency zone and its affected sub-channels. In some embodiments, the constructed IUCs may include up to 16 exception frequency zones, providing flexibility and robustness in handling diverse interference patterns across the channel. This dynamic and adaptive construction of IUCs ensures that upstream data communications remain efficient and reliable, even under varying network conditions.

In various embodiments, the PMA module further constructs IUCs 9 through 12 to account for specific frequency bands used for detecting RF energy leakage in the aeronautical band (108-137 MHz) when a specialized data packet, referred to as an Orthogonal Frequency Division Multiplexing Universal Data Packet (OUDP), is interleaved within the communication burst. For example, the PMA module may ensure sufficient reduction in modulation within a defined band of frequencies, such as those beginning at 138.1 MHz and extending to 139.7 MHz, where the OUDP carries a signal and bit pattern recognizable by sensors in the network for aeronautical band leakage detection. To achieve this, the PMA assigns one of the 16 exception frequency zones to the frequencies allocated for the OUDP and overlays an additional reduction in modulation specifically for the OUDP frequencies. This overlay modulation reduction is applied in addition to any modulation reductions determined by the PMA module for addressing channel interference or impairments based on RxMER data. Consequently, the modulation reduction within the OUDP frequency band incorporates both the noise-based reduction and the additional reduction required to support reliable OUDP transmission and detection, ensuring that the network can effectively detect and address RF energy leakage while maintaining robust upstream communication performance.

In various embodiments, the PMA module executing in the processing system constructs the IUC 13 message using RxMER data reported by cable modems over a preceding period, such as the preceding 48 hours in some embodiments. Unlike other IUCs, the default modulation for IUC 13 is specifically chosen to balance universal compatibility with all cable modems and the flexibility to support further modulation reductions within exception frequency zones. In some embodiments, this default modulation is 64-QAM, equivalent to 6 bits/Hz per symbol, which provides a sufficiently robust baseline for all cable modems while allowing for reductions in modulation levels, such as 32-QAM, 16-QAM, 8-QAM, QPSK, or BPSK, within the identified exception frequency zones. These modulation reductions accommodate channel impairments or support the interleaving of OFDM Universal Data Packets (OUDPs) as needed to ensure reliable data transmission.

In various embodiments, the PMA module applies a pre-filtering process during the construction of IUC 13 to exclude outlier RxMER data that may inaccurately skew the modulation configuration of some sub-channels. Specifically, if a cable modem's RxMER file indicates that more than a configurable threshold, such as 10% in some embodiments, or within a range of 10-20% of the sub-carriers, have an RxMER value less than or equal to a second threshold, such as 26 dB, the RxMER file is excluded from the IUC 13 configuration calculations. However, this exclusion does not apply to RxMER files reporting on mini-slots or sub-carriers within the FM radio frequency region of 88-108 MHz, as these frequencies inherently exhibit different characteristics due to ingress from FM signals.

After applying the pre-filtering process, the PMA module identifies exception frequency zones with impaired channel conditions within the frequency range of the communication channel based on the filtered RxMER files. Such frequency zones or bands correspond to frequencies in which there is ingress of RF energy from the environment or noise injected into the network, compromising transmissions of symbols and data packets sent using those frequencies. To ensure reliable communications using sub-channels encompassing exception frequency zones, the PMA module identifies reduced modulation settings for each of the identified exception frequency zones in the channel. By lowering the modulation scheme used in such sub-channels, the number of bits sent per Hz per symbol is reduced and error correction capabilities are increased, thereby enhancing the robustness of communications through the sub-channels.

After the exception frequency zones are identified and reduced modulation schemes selected for each to configure IUCs, the PMA module applies a post-filter to ensure that the overall bit rate within channels defined by the IUCs, including IUC 13, remains sufficient for reliable communications. In some embodiments, the post-filter ensures that the average bit density for the IUC 13 channel, excluding the FM ingress region of 88-108 MHz, is greater than or equal to 5 bits per Hz per symbol. The FM ingress region is excluded from this calculation because it consistently exhibits a low average bit density due to the effects of FM signal interference. By incorporating both pre-filter and post-filter processes, the PMA module constructs IUCs that balances the need for reliable, robust communication across all cable modems with the requirement for efficient and adaptive spectrum utilization, even in the presence of significant channel impairments.

In some embodiments, the PMA module may be further configured to generate an error event report whenever one or both of the pre-filter or post-filter rules are implemented during the configuration of the IUC codes. These error event reports serve to notify network operators of potential issues that may affect network performance or the reliability of upstream communications. For example, in instances in which the pre-filter excludes RxMER data from a cable modem due to a high percentage of sub-carriers with RxMER values less than or equal to 26 dB, or in instances in which the post-filter identifies that the IUC 13 average bit density is at risk of falling below the threshold of 5 bits/Hz per symbol (excluding the FM ingress region), the PMA module generates an event report documenting these occurrences.

The error event report includes detailed information about the condition that triggered the event, such as the specific RxMER data that was excluded during the pre-filter process or the calculated average bit density that necessitated corrective adjustments. Additionally, the report identifies the affected cable modems, such as by MAC address, the relevant frequency ranges or mini-slots, and any exception frequency zones that contributed to the triggering event. This information is packaged and transmitted to a designated address within the network, such as to a network operations team responsible for monitoring and maintaining network health.

Upon receiving the error event report, the network operations team can evaluate the situation and, if necessary, take corrective actions. These actions may include removing one or more cable modems from the network if they are determined to be causing significant channel impairments, initiating maintenance or repairs for physical components of the network, or adjusting system configurations to mitigate the detected issues. Additionally, a network operations team may take no action and instead wait to see if the cause of the error event report is resolved in a next cycle of RxMER data. By providing real-time notifications and detailed diagnostics, the error event reporting functionality ensures that the network remains informed about and can respond to problems that could result in network disruptions, thereby enhancing overall performance and reliability. This proactive approach enables operators to address network impairments before they escalate into more widespread issues.

Various embodiments methods for constructing IUCs, including IUC 13, particularly through the application of the described pre-filter and post-filter processes, provides significant benefits to cable service network operations by ensuring a minimum data transmission rate within channels using IUC 13. By dynamically excluding unreliable RxMER data during the pre-filter stage, such as data from sub-carriers with excessive error rates or low signal quality, various embodiments ensure that the modulation and exception frequency zone configurations are based on accurate and reliable channel performance metrics. The post-filter operations further enhance the construction of IUC 13 by verifying that the average bit density within the channel will remain above a defined threshold, such as 5 bits/Hz per symbol, after accommodating noise-based and OUDP-driven modulation reductions. This combination of filters allows IUC 13 to maintain robust and consistent data transmission rates across the channel, providing universal compatibility for all cable modems while also ensuring network efficiency and reliability under varying signal conditions. These safeguards minimize the risk of channel degradation, optimize spectrum utilization, and enhance the overall quality of upstream communications.

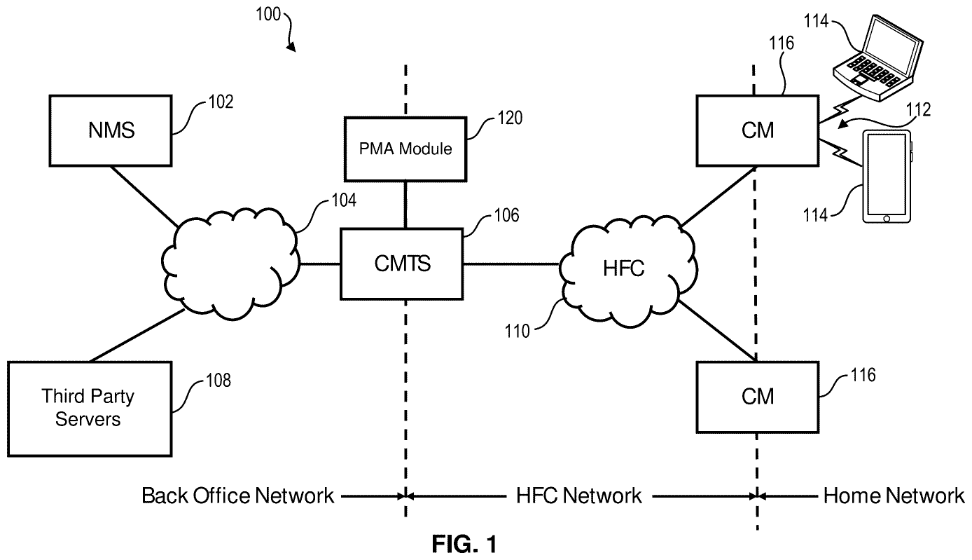

FIG. 1A is a system block diagram of a high-level representation of elements within a cable services network 100 that is suitable for implementing some embodiments. Such a network may include a network management system (NMS) 102 and third party servers 108 accessed via the Internet connected via a HyperText Transfer Protocol Secure (HTTPS) network 104 that provide network services to a CMTS 106 for distribution via a hybrid fiber/cable network (HFC) 110 to a number of cable modems 116 that may support home or business networks 112. Video, audio, and other cable services may be provided by the NMS 102 and third party servers 108 to the CMTS 106 for distribution to individual cable modems 116 for rendering on user devices 114. Additionally, user devices 114 within home or business networks 112 may send upstream communications via the network 100, such as queries to third party servers 108 hosting Internet websites. Such upstream communications may be carried from the cable modem 116 via the HFC network 110 to the CMTS 106 that routes the upstream communication to the appropriate network via the HTTPS network 104. Additionally, the cable modems 116 and the CMTS 106 exchange communications for managing download and upload communications via the HFC network 110.

Various embodiments may further include a PMA module 120 coupled to the CMTS 106, such as a software module executing within a server (e.g., within a processing system of a server) couple to the CMTS. This PMA module 120 processing system may execute processor-executable stored in non-transitory memory to perform operations of various embodiments described herein to define an IUC 13 that is provided to the CMTS 106 for enabling upstream communications from cable modems 116.

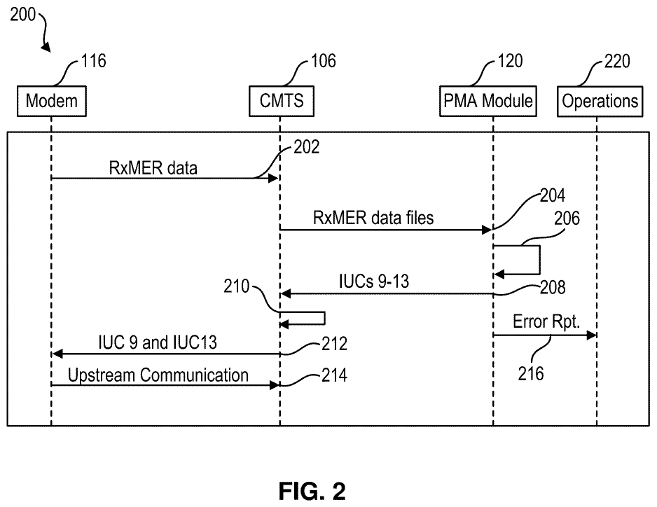

FIG. 2 is a message flow diagram illustrating exchanges of communications 200 involved in the process of constructing IUCs 9 through 13, as managed by the PMA module 120 and the CMTS 106, for use by cable modems 116 for upstream communications. The process begins with the cable modems 116 sending RxMER data files in communication 202 to the CMTS 106. These files provide the CMTS with detailed signal quality measurements over a defined time window, such as the preceding 8, 12, 24 or 48 hours, enabling the PMA module 120 to evaluate the performance of specific sub-carriers within the upstream channels. In communication 204, the CMTS 106 may provide the RxMER data files to the PMA module 120 executing in a processing system of the CMTS 106 or in a computing device (e.g., a server) coupled to the CMTS 106.

In operation 206, the PMA module 120 processes the RxMER data to configure IUCs 9 through 13. As described herein, this operation may involve dynamically identifying exception frequency zones based on impairments such as noise or interference, determining appropriate reductions in modulation schemes (e.g., from 64-QAM to 16-QAM) for those zones, and ensuring that the modulation levels meet the requirements for reliable communication. As described above, the PMA module 120 may process RxMER data over a preceding period of 8, 12, 24 or 48 hours, while the preceding period used for assessing RxMER files for identifying modulation settings and the exception frequency zones for IUC 13 may be 48 hours in some embodiments. This longer period of RxMER data may improve the reliability of IUC 13 compared to IUCs 9-12. During this operation 206, pre-filter and post-filter methods may be applied to refine the configuration of IUC 13, ensuring a minimum bit density in the channel by excluding unreliable or too limiting RxMER data, except in certain defined frequency ranges where greater amounts of RF ingress exists. The PMA module 120 also reserves one of the exception zones for the OUDP and overlays an additional modulation reduction within that band when an OUDP is present in upstream communications.

In communication 208, the PMA module 120 provides the IUC configurations to the CMTS 106, which in operation 210 selects one of IUCs 9 through 12 for the cable modem 116 (typically a service group of cable modems) based on current network conditions and assigns it to the modem 116 for upstream communications. This selection is informed by the modulation and exception zone definitions in the IUCs, enabling the CMTS 106 to adapt cable modems' upstream communications to the capabilities and network impairments of the modem 116 and channel.

In communication 212, the CMTS 106 sends the selected one of IUCs 9-12 (e.g., IUC 9 as illustrated) plus IUC 13 to the cable modems 116. The cable modems 116 then use the assigned IUC for transmitting data upstream to the CMTS 106 in communications 214.

In some embodiments, the PMA module 120 will also send an error event report 216 to a computer device, such as a computer or network monitor in a network operation 220, in response to an action (or trigger) of either the pre-filter or post-filter in the process of configuring any of IUCs 9 through 13. As described herein, this error event report 216 may identify the type of error that triggered the error event, an identity (e.g., the MAC address) of one or more cable modems (or service group of modems) that was the source of RxMER data leading to triggering of either filter, and other data that may enable operators within the network operations 220 to monitor the situation and/or take corrective actions.

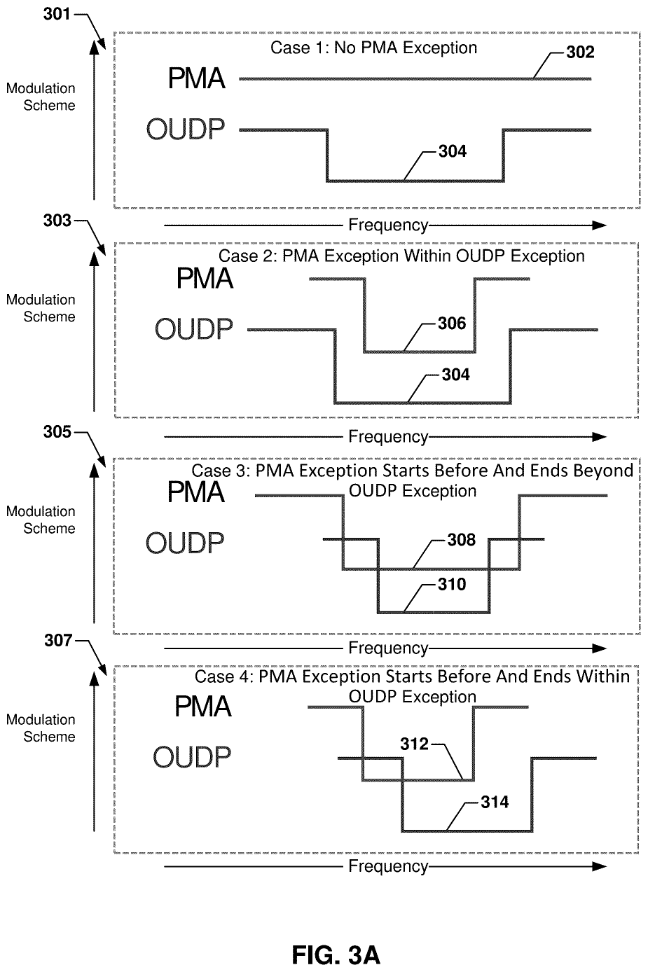

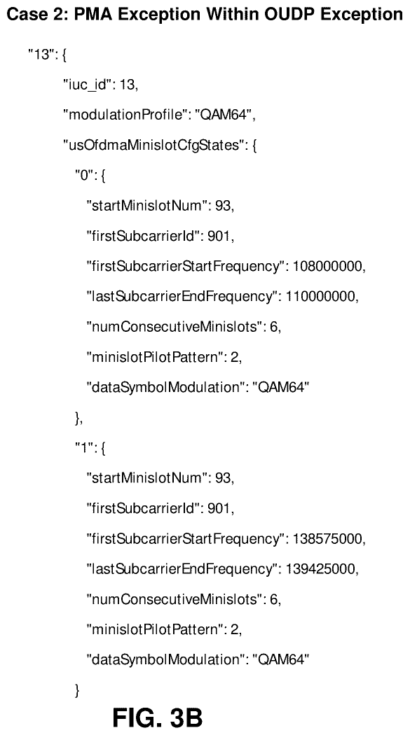

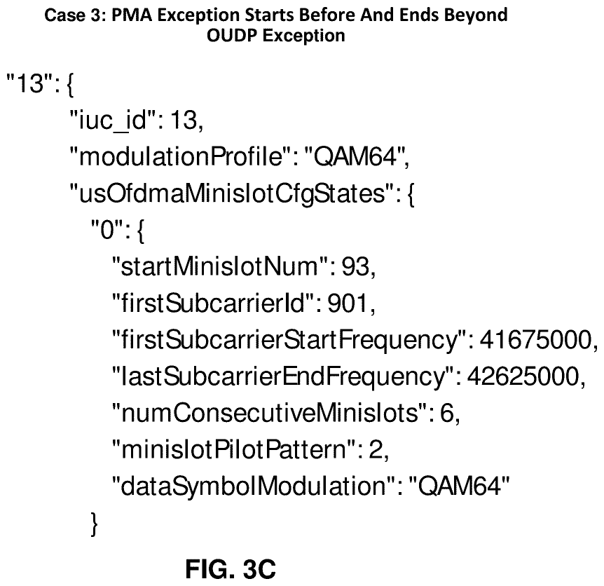

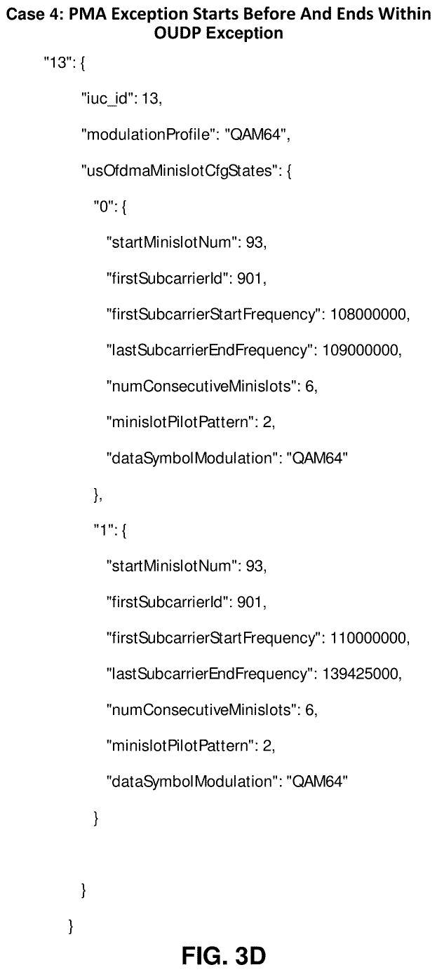

FIG. 3A illustrates four cases 301, 303, 305, 307 of overlaps in frequency ranges of PMA-identified exceptions based on RxMER data and the frequency range of the leakage detection OUDP exception frequency zone. As described above, the OUDP is a predefined pattern of bits within a narrow frequency range just above the aeronautical frequency range that can be received and recognized by sensors within the cable service network to detect when RF energy is leaking into frequencies used in commercial aircraft navigation and communications. To ensure the leakage detection data packets can be received and not interrupt upstream data communications, the leakage detection OUDP exception frequency range is given priority. Thus, the modulation identified for use in the OUDP exception frequency range is selected to be less than any modulation setting identified by the PMA module 120 for any overlapping exception frequency zone based on RxMER data. This additional reduction in modulation setting within the OUDP exception frequency range is made regardless of the overlap of the two types of exception zones. For example, in case 1 (301) in which there is no PMA-identified exception frequency zone within the leakage detection OUDP exception frequency range, only the modulation reduction of the OUDP exception will be implemented.

Case 2 (303) illustrates an example in which an exception frequency zone identified by the PMA module 120 falls within the frequency range of the OUDP exception frequency zone. As shown in FIG. 3A, the decrease in modulation in the OUDP exception frequency zone has priority over (i.e., results in lower modulation than) the PMA exception frequency zone. FIG. 3B is a code listing illustrating an example of code implementing this case 2.

Case 3 (305) illustrates an example in which a PMA-identified exception with a frequency range that starts at a frequency before (i.e., lower than) the starting (lowest) frequency of the leakage detection OUDP exception frequency zone and ends at a frequency beyond (i.e., higher than) the leakage detection OUDP exception frequency zone. As shown in FIG. 3A, the decrease in modulation in the OUDP exception frequency zone has priority over (i.e., results in lower modulation than) the PMA exception frequency zone. FIG. 3C is a code listing illustrating an example of code implementing this case 3.

Case 4 (307) illustrates an example in which a PMA identified exception with a frequency range that starts at a frequency before (i.e., lower than) the starting (lowest) frequency of the leakage detection OUDP exception frequency zone and ends at a frequency within the leakage detection OUDP exception frequency zone. As shown in FIG. 3A, the decrease in modulation in the OUDP exception frequency zone has priority over (i.e., results in lower modulation that) the PMA exception frequency zone. FIG. 3D is a code listing illustrating an example of code implementing this case 4.

Other cases of overlaps between PMA exception frequency zones and the OUDP exception frequency zone may be implemented in manners similar to those illustrated in FIGS. 3A-3D.

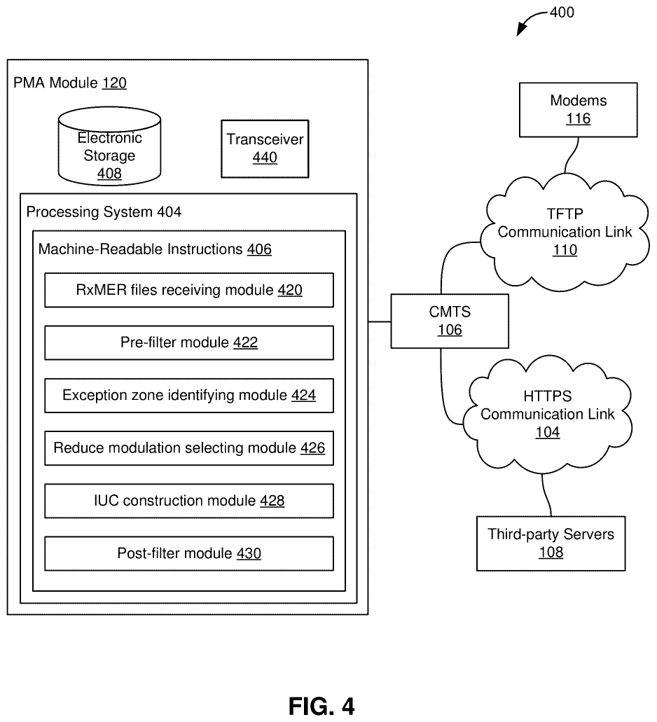

FIG. 4 is a component block diagram illustrating a system 400 for defining IUC codes, including IUC 13 codes, and supporting cable service networks in accordance with various embodiments. With reference to FIGS. 1-4, the system 400 may include an PMA module 120 that is coupled to or included as part of a CMTS 106. The CMTS 106 may communicate with cable modems 116 through a TFTP communication link 110. The CMTS 106 may communicate with third party servers 108 through a HTTPS communication link 104. The PMA module 120 may include one or more processing systems 404 coupled to electronic storage 408 and a transceiver 440. The transceiver 440 may be configured to communicate with the CMTS 106 via a direct or network communication link.

The processing system 404 may be configured by machine-readable instructions 406, which may be stored in the electronic storage 408. Machine-readable instructions 406 may include one or more instruction modules. The instruction modules may include computer program modules. In some embodiments, the functions of the instruction modules may be implemented in software, firmware, hardware (e.g., circuitry), or a combination of software and hardware, which are configured to perform particular operations or functions. The instruction modules may include one or more of a RxMER files receiving module 420, a pre-filter module 422, an exception zone identifying module 424, a reduce modulation selecting module 426, an IUC construction module 428, and a post-filter module 430, as well as other enabling and supporting software modules.

The RxMER files receiving module 420 may be configured to obtain the RxMER files for a preceding time period from the CMTS 106. In some embodiments, the RxMER files receiving module 420 query or access memory of the CMTS 106 in which RxMER data is maintained, such as in a database. In some embodiments, the RxMER files receiving module 420 may receive RxMER data from the CMTS as that data is received from cable modems, and then accumulate or store the data in a database within the electronic storage 408 accessible by the processing system 404.

The pre-filter module 422 may be configured to determine whether RxMER files include a threshold number (first threshold) of sub-channels that are below or less than a second threshold of channel quality and take actions, such as ignoring or removing from consideration any RxMER file that triggers the filter by exceeding the first threshold of unacceptable sub-channels. Further operations that may be performed by the pre-filter module 422 are described below with reference to FIG. 6A.

The exception zone identifying module 424 may be configured to identify exception frequency zones with impaired channel conditions within a frequency range of the communication channel based on the filtered RxMER files. For example, the exception zone identifying module 424 may review the RxMER files to identify frequency ranges in which modulation error rates (MER) at the default modulation or a set lower modulation exceed an acceptable error rate.

The reduce modulation selecting module 426 may be configured to identify reduced modulation settings for each of the identified exception frequency zones in the communication channel to support reliable communications. The reduce modulation selecting module 426 may reduce modulation settings based on the channel conditions to levels that will provide acceptable data communication and error rates.

The IUC construction module 428 may be configured to construct IUCs, including IUC 13, using the methods and rules described herein and according to formats defined in DOCSIS standards. In addition to defining the modulation settings for identified exception frequency zones, the IUC construction module 428 may be configured to ensure that modulation settings within the OUDP exception frequency zone is selected to be lower than any modulation setting that is identified in any overlapping exception frequency zone based on RxMER data.

The post-filter module 430 may be configured to apply a post-filter to the overall channel to ensure that an average bit density in the overall channel is greater than or equal to a minimum acceptable bit rate, such as 5 bits per Hz per symbol. Further operations that may be performed by the pre-filter module 422 are described with reference to FIG. 6A.

The electronic storage 408 may include non-transitory storage media that electronically stores information. The electronic storage media of electronic storage 408 may include one or both system storage that is provided integrally (i.e., substantially non-removable) and/or removable storage that is removably connectable to the PMA module 120 (e.g., via a universal serial bus (USB) port, a firewire port, etc.). Electronic storage 408 may include one or more virtual storage resources (e.g., cloud storage, a virtual private network, and/or other virtual storage resources). Electronic storage 408 may store software algorithms, information determined by the processing system(s) 404, information received from the CMTS 106, or other information that enables the PMA module 120 to function as described herein.

The description of the functionality provided by the different modules 420-430 is for illustrative purposes, and is not intended to be limiting, as any of modules 420-430 may provide more or less functionality than is described. For example, one or more of the modules 420-430 may be eliminated, and some or all of a module's functionality may be provided by other modules. As another example, the processing system(s) 404 may be configured to execute one or more additional modules that may perform some or all of the functionality of the modules 420-430.

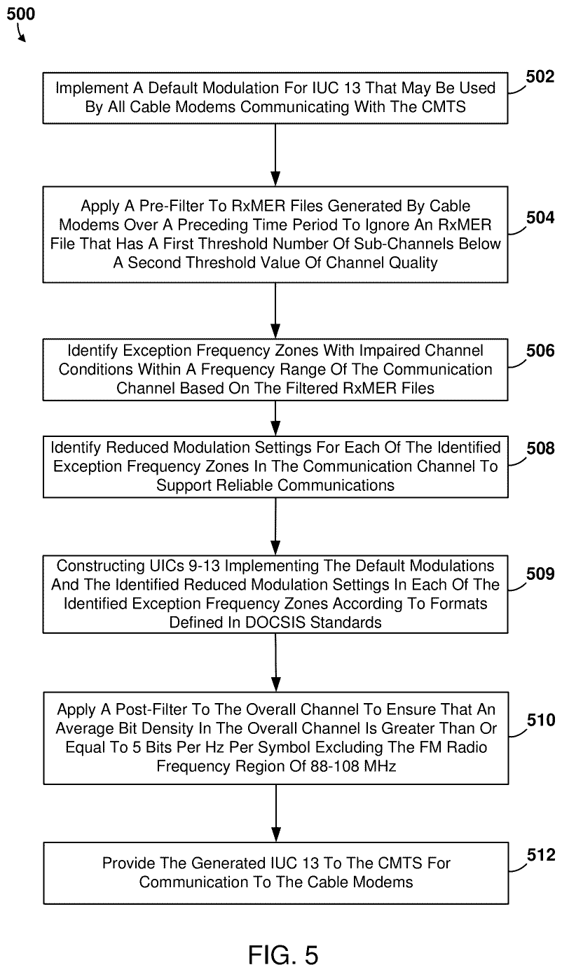

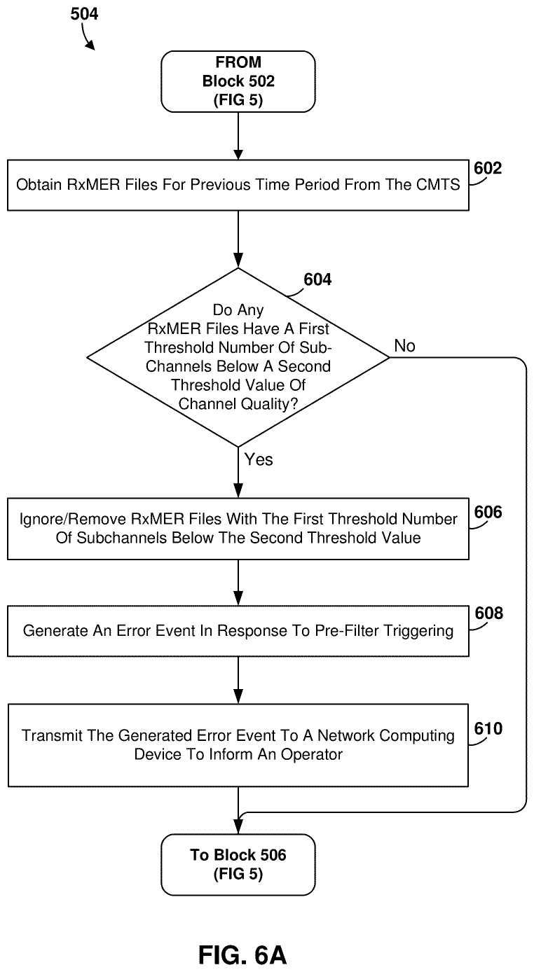

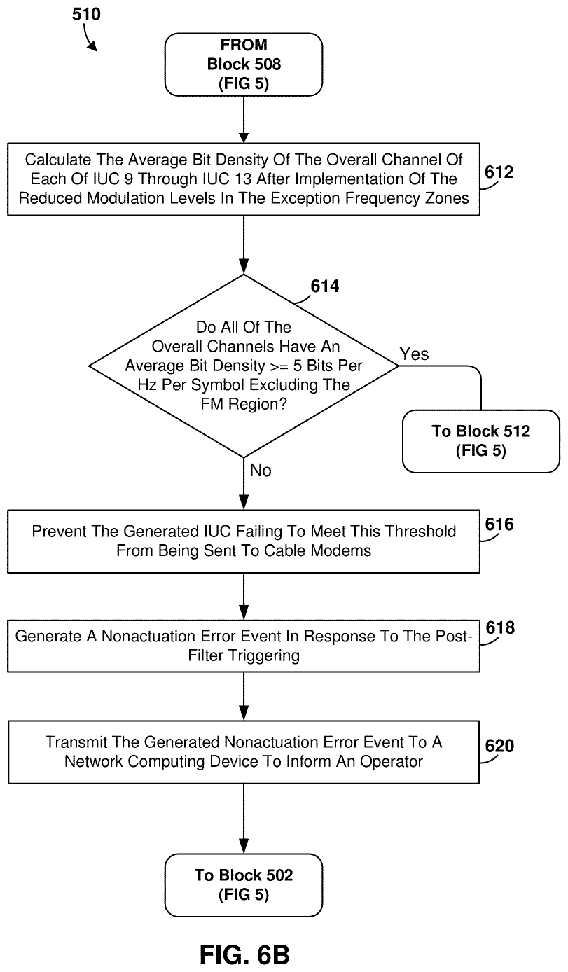

FIG. 5 is a process flow diagram illustrating a method 500 for supporting cable service network communications between cable modems 116 and a CMTS 106. With reference to FIGS. 1-5, the method 500 may be performed in a computing device, such as a server or the CMTS 106, by a processing system encompassing one or more components or subsystems discussed in this application. Means for performing the functions of the operations in method 500 may include a processing system including one or more processors and other components described herein. Further, one or more processors of a processing system may be configured with software or firmware to perform some or all of the operations of method 500. To encompass the alternative configurations enabled in various embodiments, the hardware implementing any or all of the method 500 is referred to herein as a “processing system.”

In block 502, the processing system may perform operations including constructing an IUC 13 by implementing a default modulation for a communication channel that may be used by all cable modems 116 communicating with the CMTS 106. In some embodiments, the default modulation used for the IUC 13 may be 64-QAM, equivalent to 6 bits per Hz per symbol, which provides a sufficiently robust baseline for all cable modems while allowing for reductions in modulation levels to 32-QAM, 16-QAM, 8-QAM, QPSK, or BPSK within identified exception frequency zones.

In block 504, the processing system may perform operations including applying a pre-filter to RxMER files generated by the cable modems 116 over a preceding time period to ignore an RxMER file that has a first threshold number of sub-channels below a second threshold value of channel quality. This pre-filter is not applied to sub-channels within the FM radio frequency region of 88-108 MHz as those frequencies tend to have low average bit densities due to FM interference.

In some embodiments the first threshold is within the range of 10 to 20 percent of the sub-channels (i.e., mini-slots or sub-carriers), and in some embodiments the first threshold is 10 percent of the sub-channels. In some embodiments, the second threshold may be 26 dB or within a range of 20-30 dB. In some embodiments, either or both of the first and second thresholds may be configurable, such as by software executing within or supervising the PMA module 120 and executing within the processing system or coupled to the CMTS 106.

Further operations involved in applying the pre-filter in block 504 are described with reference to FIG. 6A below.

In block 506, the processing system may perform operations including identifying exception frequency zones with impaired channel conditions within a frequency range of the communication channel based on the filtered RxMER files. As described herein, these operations may include reviewing the RxMER files to identify frequencies in which modulation error rates at the default modulation or a set lower modulation exceed an acceptable error rate. This analysis may identify a frequency range within which modulation errors occur and define that frequency range (optionally with frequency margins at the start and end frequencies) as an exception frequency zone. In instances in which an OUDP for monitoring leakage of signal in the aeronautical band is transmitted in the communication channel, the processing system performs operations to reserve one of the 16 exception frequency zones for the OUDP pattern.

In block 508, the processing system may perform operations including identifying reduced modulation settings for each of the identified exception frequency zones in the communication channel to support reliable communications. In some embodiments, these operations may include selecting a reduced modulation setting (e.g., one of 32-QAM, 16-QAM, 8-QAM, QPSK, or BPSK) that provides sufficient demodulation robustness to satisfy acceptable error rates in view of the channel quality reflected in the RxMER data. In the case of very poor channel quality within an exception frequency zone, the reduced modulation setting may be no modulation, in which no bits will be transmitted within the frequency zone. In instances in which an OUDP for monitoring leakage of signal in the aeronautical band is transmitted in the communication channel and an exception frequency zones is reserved for the OUDP pattern, the processing system performs operations to ensure that the modulation identified for use in the exception frequency zone reserved for the OUDP pattern is selected to be less than any modulation setting identified for any overlapping exception frequency zone based on RxMER data.

In block 509, the processing system may perform operations including constructing UICs 9-13 implementing the default modulations and the identified reduced modulation settings in each of the identified exception frequency zones according to formats defined in DOCSIS standards.

In block 510, the processing system may perform operations including applying a post-filter to the overall channel to ensure that an average bit density in the overall channel is greater than or equal to 5 bits per Hz per symbol. Application of the post-filter may exclude the FM radio frequency region of 88-108 MHz due to the level of ingress interference that may occur in these frequencies. A description of operations that may be performed in block 510 is provided below with reference to FIG. 6B.

In block 512, the processing system may perform operations including providing the generated IUC 13 to the CMTS 106 for communication to the cable modems 116. In implementations in which the processing system is within a computing device (e.g., a server) coupled to the CMTS 106, the IUC 13, along with IUCs 9-12, may be communicated to the CMTS 106 via a data cable or network connection. In implementations in which the processing system is within the CMTS 106, the IUC 13, along with IUCs 9-12, may be posted to memory for access by the CMTS 106 when transmitting IUCs to connected cable modems 116.

FIGS. 6A and 6B are process flow diagrams illustrating additional operations that may be performed in blocks 504 and 510, respectively, of the method 500. With reference to FIGS. 1-6B, the additional operations in blocks 504 and 510 may be performed in a computing device, such as a server or the CMTS 106, by a processing system encompassing one or more components or subsystems discussed in this application. Means for performing the functions of the additional operations in blocks 504 and 510 may include a processing system including one or more processors and other components described herein. Further, one or more processors of a processing system may be configured with software or firmware to perform some or all of the additional operations in blocks 504 and 510. To encompass the alternative configurations enabled in various embodiments, the hardware implementing any or all of the additional operations is referred to herein as a “processing system.”

Referring to FIG. 6A, in some embodiments, applying a pre-filter to RxMER files may include the processing system obtaining the RxMER files for a preceding time period from the CMTS 106 in block 602. In some embodiments, the time period of RxMER data used by the processing system may be the preceding 48 hours for constructing IUC 13 to provide sufficient data to provide a conservative assessment of the channel quality, while the processing system may use RxMER data spanning a preceding 8, 12, 24 or 48 hours. In some embodiments, the operations in block 602 may include querying or accessing a memory of the CMTS 106 in which RxMER data is maintained, such as in a database. In some embodiments, the operations in block 602 may include receiving RxMER data from the CMTS 106 as that data is received from cable modems 116 and then accumulating or storing the data in a database accessible by the processing system.

In determination block 604, the processing system may determine whether RxMER files include a threshold number (first threshold) of sub-channels that are below or less than a second threshold of channel quality. As described above, in some embodiments, the first threshold is within the range of 10 to 20 percent of the sub-channels (i.e., mini-slots or sub-carriers), and in some embodiments, the first threshold is 10 percent of the sub-channels. In some embodiments, the second threshold may be 26 dB or within a range of 20-30 dB. In some embodiments, either or both of the first and second thresholds may be configurable, such as by software executing within or supervising the PMA module 120 and executing within the processing system within or coupled to the CMTS 106.

In response to determining that none of the RxMER files satisfies the pre-filter condition because fewer than the first threshold (e.g., less than 10 percent) of sub-channels have channel quality levels less than the second threshold (e.g., less than or equal to 26 dB) (i.e., determination block 604=No), the processing system may perform the operations in block 506 to identify exception frequency zones with impaired channel conditions as described with reference to FIG. 5.

In response to determining that one or more of the RxMER files satisfies the pre-filter because at least the first threshold (e.g., <10 percent) of sub-channels have channel quality levels less than or equal to the second threshold (e.g., <=26 dB) (i.e., determination block 604=Yes), the processing system may perform operations including ignoring or removing from calculations the RxMER file or files that satisfy the pre-filter condition in block 606. By ignoring such RxMER files, the processing system may ensure that the IUCs are not biased by one or a few cable modems experiencing or reporting unacceptable levels of modulation errors. In effect, the processing system may construct IUCs, including IUC 13, based on error reports from the majority (e.g., approximately 95 percent) of the cable modems 116 in a service group.

In block 608, the processing system may perform operations including generating an error event in response to the pre-filter triggering (i.e., the pre-filter condition being met). Such an error event may identify the IUC and the cable modem(s) 116 providing the RxMER data, such as the MAC addresses of modems reporting such data, to support network operations, such as troubleshooting or network reconfigurations.

In block 610, the processing system may perform operations including transmitting the generated error event report to a computing system, such as a network operator's computing system or monitor to inform network operators or managers of the unacceptable RxMER situation so that appropriate actions can be taken to address the situation.

The processing system may then perform the operations in block 506 to identifying exception frequency zones with impaired channel conditions within a frequency range of the communication channel based on the filtered RxMER files. as described with reference to FIG. 5.

Referring to FIG. 6B, in some embodiments, the processing system may apply a post-filter to the IUCs, including IUC 13, constructed in block 512 to ensure that an average bit density in the overall channel is greater than or equal to a minimum average bit rate, such as 5 bits per Hz per symbol excluding the FM radio frequency region of 88-108 MHz.

In block 612, the processing system may perform operations including calculating the average bit density of the overall channel of each of IUC 9 through IUC 13 after implementation of the reduced modulation levels in the exception frequency zones. In some embodiments, the processing system may calculate the average bit rate of each communication channel after identifying exception frequency zones and applying reduced modulation settings within those zones. As described herein, IUCs identify the sub-channels (i.e., mini-slots or sub-carriers) and different modulation settings for sub-channels in exception frequency zones that cable modems use in upstream communications. In block 612, the processing system calculates the average bit rate for an IUC by determining the modulation applied to each sub-channel within the channel, including the reduced modulation settings assigned to exception frequency zones, and computing an average bit rate across all sub-channels. This average bit rate represents the effective rate of data transfer achievable using the IUC. The processing system may further refine this calculation by querying the CMTS 106 to determine which IUCs were actually utilized for transmitted traffic, allowing the processing system to calculate a weighted average bit rate for all cable modems 116 in a service group. By aggregating this data, the processing system may generate a comprehensive average bit rate for the entire service group, considering the modulation levels applied across all channels and IUCs, including the impacts of exception frequency zones.

In determination block 614, the processing system may determine whether all of the overall channels have an average bit density greater than or equal to threshold bits per Hz per symbol, excluding the FM region. In some embodiments, the threshold may be within a range of 4-6 bits per Hz per symbol, and in some embodiments, the threshold may be 5 bits per Hz per symbol as illustrated in FIG. 6B.

In response to determining that all of the IUC defined channels have average bit density greater than or equal to threshold bits per Hz per symbol (e.g., >=5 bits/Mz/symbol) (i.e., determination block 614=“Yes”), and thus the post-filter is not triggered, the processing system may perform the operations in block 512 to provide the generated IUCs to the CMTS for transmission to cable modems as described with reference to FIG. 5.

In response to determining that the post-filter is triggered because one or more of the IUCs define a channel with an average bit density less than the acceptance threshold (i.e., determination block 614=“No”), the processing system may prevent the generated IUC failing to meet this threshold from being sent to cable modems in block 616. In these operations the processing system may abandon activation of the constructed IUCs, informing the CMTS to not act on or use the IUCs so the system can wait for the next cycle of RxMER data. This prevents using an IUC that could lead to a network or communication failure.

In block 618, the processing system may perform operations including generating an error event (e.g., a non-actuation error event) in response to the post-filter triggering. This error event may include information such as the IUC or IUCs that triggered the post-filter, the MAC addresses of the cable modems 116 or the service group of modems that is the source of errors resulting in triggering of the post-filter, and other information useful for performing troubleshooting or correcting the cause of network issues.

In block 620, the processing system may perform operations including transmitting the generated error event report (e.g., a non-actuation error event) to a network computing device to inform an operator of the event. The information included in the error event report may enable network operators or managers to take corrective actions, such as replacing defective plant equipment, replacing damaged coaxial cables, replacing cable modems, and repairing or replacing other plant or network equipment that are a source of the problems. Alternatively, operators may monitor the error event but delay taking action to determine whether the error self-corrects in a next cycle as may occur when the source of the problem is a limited episode of excess interference on a part of the network. Thus, the processing system may thereafter perform the operations of block 502 to repeat the operations to generate IUCs, including IUC 13, in a next cycle of RxMER data.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the other methods, and vice versa.

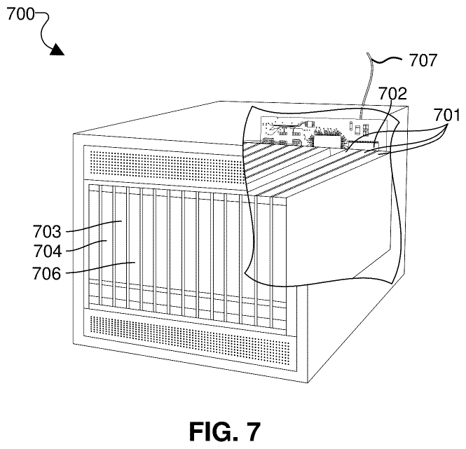

Various embodiments (including, but not limited to, embodiments discussed above with reference to FIGS. 1-6B) may be implemented on any of a variety of commercially available computing devices, such as the server computing device 700 illustrated in FIG. 7. Such a server device 700 may include a processor 701 coupled to volatile memory 702 and a large capacity nonvolatile memory, such as a disk drive 703. The server device 700 may also include a floppy disc drive 704, USB, compact disc (CD) or DVD disc drive coupled to the processor 701. The server device 700 may also include network access ports 707 coupled to the processor 701 for establishing data connections with a network connection circuit 706 and a communication network (e.g., an HTTPS network 104) coupled to other communication system network elements.

The following paragraphs list example embodiment methods. Further embodiments include a computing device having a memory and a processing system configured with processor-executable instructions to perform operations of any of the following example method embodiments. Further embodiments include a non-transitory processor-readable medium on which are stored processor-executable instructions configured to cause a processing system to perform operations of any of the following example method embodiments.

Example 1. A method performed by a computing device for formatting Interval Usage Codes (IUCs) for supporting network communications between modems and a network controller, including: constructing an IUC 13 code by: implementing a default modulation for a communication channel using IUC 13 that can be used by all modems communicating with the network controller; applying a pre-filter to RxMER files generated by the modems over a preceding time period to ignore an RxMER file that has a first threshold number of sub-channels below a second threshold value of channel quality, this pre-filter not applying to sub-channels within the FM radio frequency region of 88-108 MHz; identifying up to 16 exception frequency zones with impaired channel conditions within a frequency range of the communication channel based on the filtered RxMER files; identifying reduced modulation settings for each of the identified exception frequency zones in the communication channel to support reliable communications; and applying a post-filter to the overall channel to ensure that an average bit density in the overall channel is greater than or equal to 5 bits per Hz per symbol excluding the FM radio frequency region of 88-108 MHz; and providing the generated IUC 13 to the network controller for communication to the modems.

Example 2. The method of example 1, in which the first threshold value and the second threshold value are definable in software.

Example 3. The method of any of examples 1-2, in which the first threshold value is between 10 percent and 20 percent of sub-carriers in the channel, and the second threshold value is 26 dB.

Example 4. The method of any of examples 1-3, in which the default modulation for IUC 13 is QAM-64.

Example 5. The method of any of examples 1-4, in which the preceding time period of RxMER files used for constructing the IUC 13 code is at least 48 hours.

Example 6. The method of any of examples 1-5, in which IUC 13 includes up to 16 exception frequency zones.

Example 7. The method of any of examples 1-6, further including: generating an error event in response to either of the pre-filter or post-filter being triggered; and transmitting the generated error event to a network computing device to inform an operator.

Example 8. The method of any of examples 1-7, further including configuring one or more of IUC 9 through IUC 12 based on RxMER files generated by modems using a respective IUC over a preceding period that is less than or equal to the preceding period of RxMER data used in constructing the IUC 13 code, in which IUC 9 through IUC 12 can have up to 16 exception frequency zones, and in which the exception frequency zones identified for IUC 13 match a combination of the exception frequency zones in IUC 9 through IUC 12.

Example 9. The method of example 8, in which: when an OUDP for monitoring leakage of signal in the aeronautical band is transmitted in the communication channel, one of the 16 exception frequency zones is reserved for the OUDP pattern; and the modulation identified for use in the exception frequency zone reserved for the OUDP pattern is selected to be less than any modulation setting identified for any overlapping exception frequency zone based on RxMER data.

Example 10. The method of any of examples 8-9, further including configuring each of IUC 9 through IUC 12 to have the same default modulation.

The processors discussed in this application may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors. The processors may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into the device and memory within the processors themselves. Additionally, as used herein, any reference to a memory may be a reference to a memory storage and the terms may be used interchangeable.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module and/or processor-executable instructions, which may reside on a non-transitory computer-readable or non-transitory processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method performed by a computing device for formatting Interval Usage Codes (IUCs) for supporting cable service network communications between modems and a network controller, comprising:
constructing an IUC 13 code by:
implementing a default modulation for a communication channel using IUC 13 that is used by all modems communicating with the network controller;
applying a pre-filter to Received Modulation Error Ratio (RxMER) files generated by the modems over a preceding time period to ignore an RxMER file that has a first threshold number of sub-channels below a second threshold value of channel quality, this pre-filter not applying to sub-channels within the FM radio frequency region of 88-108 MHz;
identifying up to 16 exception frequency zones with impaired channel conditions within a frequency range of the communication channel based on the filtered RxMER files;
identifying reduced modulation settings for each of the identified exception frequency zones in the communication channel to support reliable communications; and
applying a post-filter to the overall channel to ensure that an average bit density in the overall channel is greater than or equal to 5 bits per Hz per symbol excluding the FM radio frequency region of 88-108 MHz; and
providing the generated IUC 13 to the network controller for communication to the modems.

2. The method of claim 1, wherein the first threshold value and the second threshold value are definable in software.

3. The method of claim 1, wherein the first threshold value is between 10 percent and 20 percent of sub-carriers in the channel, and the second threshold value is 26 dB.

4. The method of claim 1, wherein the default modulation for IUC 13 is Quadrature Amplitude Modulation (QAM)-64.

5. The method of claim 1, wherein the preceding time period of RxMER files used for constructing the IUC 13 code is at least 48 hours.

6. The method of claim 1, wherein IUC 13 includes up to 16 exception frequency zones.

7. The method of claim 1, further comprising:
generating an error event in response to either of the pre-filter or post-filter being triggered; and
transmitting the generated error event to a network computing device to inform an operator.

8. The method of claim 1, further comprising configuring one or more of IUC 9 through IUC 12 based on RxMER files generated by modems using a respective IUC over a preceding period that is less than or equal to the preceding period of RxMER data used in constructing the IUC 13 code, wherein IUC 9 through IUC 12 can have up to 16 exception frequency zones, and wherein the exception frequency zones identified for IUC 13 match a combination of the exception frequency zones in IUC 9 through IUC 12.

9. The method of claim 8, wherein:
when an Orthogonal Frequency Domain Modulation (OFDMA) Universal data packet (OUDP) for monitoring leakage of signal in the aeronautical band is transmitted in the communication channel, one of the 16 exception frequency zones is reserved for the OUDP pattern; and
the modulation identified for use in the exception frequency zone reserved for the OUDP pattern is selected to be less than any modulation setting identified for any overlapping exception frequency zone based on RxMER data.

10. The method of claim 8, further comprising configuring each of IUC 9 through IUC 12 to have the same default modulation.

11. A computing device, comprising:
a memory; and
a processing system coupled to the memory and to a network controller, and configured with processor-executable instructions stored in the memory to perform operations for supporting network communications between modems and the network controller, the operations comprising:
constructing an IUC 13 code by:
implementing a default modulation for a communication channel using IUC 13 that is used by all modems communicating with the network controller;
applying a pre-filter to Received Modulation Error Ratio (RxMER) files generated by the modems over a preceding time period to ignore an RxMER file that has a first threshold number of sub-channels below a second threshold value of channel quality, this pre-filter not applying to sub-channels within the FM radio frequency region of 88-108 MHz;
identifying up to 16 exception frequency zones with impaired channel conditions within a frequency range of the communication channel based on the filtered RxMER files;
identifying reduced modulation settings for each of the identified exception frequency zones in the communication channel to support reliable communications; and
applying a post-filter to the overall channel to ensure that an average bit density in the overall channel is greater than or equal to 5 bits per Hz per symbol excluding the FM radio frequency region of 88-108. MHz; and
providing the generated IUC 13 to the network controller for communication to the modems.

12. The computing device of claim 11, wherein the first threshold value and the second threshold value are definable in software.

13. The computing device of claim 11, wherein the first threshold value is between 10 percent and 20 percent of sub-carriers in the channel, and the second threshold value is 26 dB.

14. The computing device of claim 11, wherein the default modulation for IUC 13 is Quadrature Amplitude Modulation (QAM)-64.

15. The computing device of claim 11, wherein the preceding time period of RxMER files used for constructing the IUC 13 code is at least 48 hours.

16. The computing device of claim 11, wherein IUC 13 includes up to 16 exception frequency zones.

17. The computing device of claim 11, wherein the processing system is further configured with processor-executable instructions stored in the memory to perform operations further comprising:
generating an error event in response to either of the pre-filter or post-filter being triggered; and
transmitting the generated error event to a network computing device to inform an operator.

18. The computing device of claim 11, wherein the processing system is further configured with processor-executable instructions stored in the memory to perform operations further comprising:
configuring one or more of IUC 9 through IUC 12 based on RxMER files generated by modems using a respective IUC over a preceding period that is less than or equal to the preceding period of RxMER data used in constructing the IUC 13 code, wherein IUC 9 through IUC 12 can have up to 16 exception frequency zones, and wherein the exception frequency zones identified for IUC 13 match a combination of the exception frequency zones in IUC 9 through IUC 12.

19. The computing device of claim 18, wherein:
when an Orthogonal Frequency Domain Modulation (OFDMA) Universal data packet (OUDP) for monitoring leakage of signal in the aeronautical band is transmitted in the communication channel, one of the 16 exception frequency zones is reserved for the OUDP pattern; and
the modulation identified for use in the exception frequency zone reserved for the OUDP pattern is selected to be less than any modulation setting identified for any overlapping exception frequency zone based on RxMER data.

20. The computing device of claim 18, wherein the processing system is further configured with processor-executable instructions stored in the memory to perform operations further comprising:
configuring each of IUC 9 through IUC 12 to have the same default modulation.

21. A non-transitory, processor-readable medium having stored thereon processor-executable instructions configured to cause a processing system to perform operations comprising:
constructing an IUC 13 code by:
implementing a default modulation for a communication channel using IUC 13 that is used by all modems communicating with a network controller;
applying a pre-filter to Received Modulation Error Ratio (RxMER) files generated by the modems over a preceding time period to ignore an RxMER file that has a first threshold number of sub-channels below a second threshold value of channel quality, this pre-filter not applying to sub-channels within the FM radio frequency region of 88-108 MHz;
identifying up to 16 exception frequency zones with impaired channel conditions within a frequency range of the communication channel based on the filtered RxMER files;
identifying reduced modulation settings for each of the identified exception frequency zones in the communication channel to support reliable communications; and
applying a post-filter to the overall channel to ensure that an average bit density in the overall channel is greater than or equal to 5 bits per Hz per symbol excluding the FM radio frequency region of 88-108 MHz; and
providing the generated IUC 13 to the network controller for communication to the modems.
